(19) United States
(12) Patent Application Publication
(10) Pub. No.: US 2022/0046028 A1
(43) Pub. Date: Feb. 10, 2022

(54) METHOD AND SYSTEM FOR DETERMINING A STATE OF AN ACCOUNT IN A NETWORK DEVICE RUNNING A LIGHT CLIENT PROTOCOL OF A DISTRIBUTED LEDGER TECHNOLOGY NETWORK

(71) Applicant: Telefonaktiebolaget LM Ericsson (publ), Stockholm (SE)

(72) Inventors: Santeri PAAVOLAINEN, Masala (FI); Abu Shohel AHMED, Espoo (FI)

(73) Assignee: Telefonaktiebolaget LM Ericsson (publ), Stockholm (SE)

(21) Appl. No.: 17/299,230

(22) PCT Filed: Dec. 5, 2018
(86) PCT No.: PCT/EP2018/083652

§ 371 Date: Jun. 2, 2021

(51) Int. Cl. H04L 29/06; G06Q 20/38; G06F 16/27

(52) U.S. Cl. CPC H04L 63/12; G06F 16/27; G06Q 20/389

(57) ABSTRACT

Methods and network devices for determining a state of an account of interest in a distributed ledger technology (DLT) network are described. The determination of the state of the account of interest is performed based on a DLT state indicator that is a representation of a state of the DLT network that is trusted by the network device. The network device determines whether the DLT state indicator is indicative of the state of the account of interest. Responsive to determining that the DLT state indicator is indicative of the state of the account of interest, the network device retrieves the state of the account of interest based on the DLT state indicator. Responsive to determining that the DLT state indicator is not indicative of the state of the account of interest, the network device performs the following operations: determining a first set of one or more transactions that include the account of interest and executing the first set of transactions to obtain the state of the account of interest.

### TECHNICAL FIELD

The present disclosure relates to the field of distributed ledger technology; and more specifically, to mechanisms for determining a state of an account in a network device running a light client protocol of a distributed ledger technology network.

### BACKGROUND

Internet of Things (IoT) devices are electronic devices which often have reduced capabilities. For example, most IoT devices have a limited amount of processing power, memory, storage, and are often running all the time, or periodically on battery power.

Distributed ledger technology (DLT) systems are platforms used for building, running, and deploying a decentralized, distributed and public distributed digital ledger. In a DLT system a digital ledger permanently records digital records of transactions that occur between two parties. The records cannot be altered retroactively without the alteration of all subsequent transactions in the digital ledger and without consensus from other nodes in the network. This allows the participants to verify and audit transactions inexpensively and securely. A digital ledger is maintained without a central authority or implementation. For example, the digital ledger can be a blockchain that includes blocks secured and linked to one another using cryptographic mechanisms.

With the advent of distributed ledger technologies, the question of whether it is possible to use DLTs in network with IoT devices arises. A potential use case is to use smart contracts residing in distributed ledgers as sources or sinks of information. An application that can be contemplated is the use of the smart contracts for the secure configuration of the IoT devices.

However, reduced capability network devices are not suitable to operate as full nodes in distributed ledgers as they don't have the resources to perform validation operations and/or storage of a ledger's state due to the limit of available resources. An alternative approach is to use a light client protocol (e.g., Simplified Payment Verification (SPV) in Bitcoin or Light Ethereum (LES) in Ethereum are examples of light client protocols) in the reduced capability devices.

Light client protocols allow reduced capability devices to query the state of the DLT network, send transactions, and check transaction results. However, these functionalities of the light client protocol do not provide the same security guarantees that are available to full DLT protocol operating in full nodes of the DLT network. Typically, a device running the light client protocol receives the DLT network's state from an intermediary network device that connects the network device to the rest of the DLT network. This intermediary network device can be a malicious device and may not provide an accurate state of the DLT network to the reduced capability network device. For example, in a blockchain network, the intermediary network device can transmit to the reduced capability network device a state of the blockchain that may be internally consistent but is globally inconsistent. Thus, although full security is only possible for a full node in the DLT network, a light client protocol allows light nodes to process data and to receive data from the network about sections of the digital ledger that are of interest to them.

Reduced capability devices (e.g., IoT devices) are usually poorly connected to other nodes of the distributed ledger. When a reduced capability device is connected to the other nodes of the distributed ledger, it is often through a single intermediary network device (e.g., base station (BS), gateway, etc.) that acts as a bottleneck to the network. The intermediary network device makes it impossible for a reduced capability device running a light client protocol to trust the communication it has with independent full nodes of the distributed ledger. For example, reduced capability NDs may not be able to obtain an accurate and trusted state of an account of interest without processing the validating transactions from the entire digital ledger.

### SUMMARY

One general aspect includes a method performed by a network device of determining a state of an account of interest in a distributed ledger technology (DLT) network, the method including: determining whether a DLT state indicator is indicative of the state of the account of interest, where the DLT state indicator is a representation of a state of the DLT network that is trusted by the network device; responsive to determining that the DLT state indicator is indicative of the state of the account of interest, retrieving the state of the account of interest based on the DLT state indicator; and responsive to determining that the DLT state indicator is not indicative of the state of the account of interest, performing the following: determining a first set of one or more transactions that include the account of interest. The method also includes executing the first set of transactions to obtain the state of the account of interest.

One general aspect includes a network device for determining a state of an account of interest in a distributed ledger technology (DLT) network, network device including: one or more processors; and a computer readable storage medium storing a set of computer readable instructions that when executed by the one or more processors cause the network device to: determine whether the DLT state indicator is indicative of the state of the account of interest, where the DLT state indicator is a representation of a state of the DLT network that is trusted by the network device; responsive to determining that the DLT state indicator is indicative of the state of the account of interest, retrieve the state of the account of interest based on the DLT state indicator, and responsive to determining that the DLT state indicator is not indicative of the state of the account of interest, perform the following: determine a first set of one or more transactions that include the account of interest; and execute the first set of transactions to obtain the state of the account of interest.

One general aspect includes a method performed by a first network device in a distributed ledger technology (DLT) network, the method including: executing transactions of the DLT network; storing for each transaction from the transactions an input set that includes identifiers of one or more accounts that are input to the transaction and an output set that includes identifiers of one or more accounts that are outputs of execution of the transaction; receiving, from a second network device, a request for transactions that include an account; determining, based on at least one of the input sets and the output sets, a set of one or more transactions from the transactions, where each transaction from the set of transactions includes the account as at least one of an output and an input; and transmitting the set of transactions to the second network device.

One general aspect includes a first network device in a distributed ledger technology (DLT) network, the first network device including: one or more processors; and a computer readable storage medium storing a set of computer readable instructions that when executed by the one or more processors cause the first network device to: execute transactions of the DLT network; store for each transaction from the transactions an input set that includes identifiers of one or more accounts that are input to the transaction and an output set that includes identifiers of one or more accounts that are outputs of execution of the transaction; receive, from a second network device, a request for transactions that include an account; determine, based on at least one of the input sets and the output sets, a set of one or more transactions from the transactions, where each transaction from the set of transactions includes the account as at least one of an output and an input; transmit the set of transactions to the second network device.

### BRIEF DESCRIPTION OF THE DRAWINGS

The present disclosure may best be understood by referring to the following description and accompanying drawings that are used to illustrate embodiments of the present disclosure. In the drawings:

FIG. 1 illustrates a block diagram of an exemplary distributed ledger network for enabling a network device to determine a state of an account of interest based on a trusted state indicator of the DLT network, in accordance with some embodiments.

FIG. 2A illustrates a block diagram of exemplary operations for obtaining a state indicator of the DLT network, in accordance with some embodiments.

FIG. 2B illustrates a block diagram of exemplary operations for determining a state of an account of interest in the DLT network based on the state indicator, in accordance with some embodiments.

FIG. 2C illustrates a block diagram of exemplary operations for determining a state of an account of interest in the DLT network based on the state indicator, in accordance with some embodiments.

FIG. 3 illustrates a flow diagram of exemplary operations for determining a state of an account of interest based on a state indicator of the DLT network, in accordance with some embodiments.

FIG. 4 illustrates a flow diagram of exemplary operations for retrieving the state of an account when the DLT state indicator is indicative of the account, in accordance with some embodiments.

FIG. 5 illustrates a flow diagram of exemplary operations for determining a set of transactions that include the account of interest, in accordance with some embodiments.

FIG. 6 illustrates a flow diagram of exemplary operations for executing the first set of transactions to obtain the state of the account of interest, in accordance with some embodiments.

FIG. 7 illustrates a flow diagram of exemplary operations performed in a network device operating as a full DLT node, in accordance with some embodiments.

FIG. 8 illustrates a block diagram for a network device that can be used for implementing one or more of the network devices described herein, in accordance with some embodiments.

FIG. 9 illustrates a block diagram for a network device that can be used for implementing a reduced network device, in accordance with some embodiments.

### DETAILED DESCRIPTION

The following description describes methods and apparatus for determining a state of an account in a network device running a light client protocol of a distributed ledger technology network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that the embodiments may be practiced without such specific details. In other instances, control structures, gate level circuits and full software instruction sequences have not been shown in detail in order not to obscure the embodiments. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to some embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Existing Solutions for Obtaining a Trusted Representation of a Digital Ledger's State:

As mentioned above, light client protocols allow reduced capability devices to query the state of the DLT network, send transactions, and check transaction results. However, these functionalities of the light client protocol do not provide the same security guarantees that are available to full DLT protocol operating in full nodes of the DLT network. Typically, a device running the light client protocol receives the DLT network's state from an intermediary network device that connects the network device to the rest of the DLT network. This intermediary network device can be a malicious device and may not provide an accurate state of the DLT network to the reduced capability network device. For example, in a blockchain network, the intermediary network device can transmit to the reduced capability network device a state of the blockchain that may be internally consistent but is globally inconsistent. Thus, although full security is only possible for a full node in the DLT network, a light client protocol allows light nodes to process data and to receive data from the network about sections of the digital ledger that are of interest to them.

Reduced capability devices (e.g., IoT devices) are usually poorly connected to other nodes of the distributed ledger. When a reduced capability device is connected to the other nodes of the distributed ledger, it is often through a single intermediary network device (e.g., base station (BS), gateway, etc.) that acts as a bottleneck to the network. The intermediary network device makes it impossible for a reduced capability device running a light client protocol to trust the communication it has with independent full nodes of the distributed ledger while having reduced storage, processing, and network resources.

For example, in blockchain networks due to the possibility of forks in the chain of blocks, a full node in the blockchain network needs to be ready to unroll some of the state changes, and re-start state-chancing transactions from an earlier point in time. The full node uses significant processing resources to process the transactions as well as significant network capacity to receive all blocks and transactions from other nodes. The blocks need to be transferred over the network. These requirements storage, processing, and networking resources—make it challenging for reduced capability network devices to be full nodes on the blockchain network.

Thus, the security of reduced capability NDs operating in a DLT network is by default compromised due to the necessity of using a light blockchain protocol. Since many reduced capability devices are either static or situated behind an intermediary ND, there are several opportunities for other devices in the network to subvert the view of the DLT network that is obtained by the reduced capability ND. This makes these reduced capability NDs particularly vulnerable when using light client protocols. For example, reduced capability NDs may not be able to obtain an accurate and trusted state of an account of interest without processing the validating transactions from the entire digital ledger.

Several solutions exist for enabling network devices of a digital ledger network to determine a state of an account of interest. In one solution, a DLT platform can add separate nodes that can validate a portion of the digital ledger (e.g., a portion of unspent transaction output (UTXO)) without processing all of the transactions of the digital ledger. An example of such a solution is Dietcoin, which is an extension to the Bitcoin network. In this extension, “diet” nodes are added to the network. These nodes validate portions of UTXO without processing all the transactions recorded in the blockchain of Bitcoin. Dietcoin operates by sharding transactions and downloading only those shards that are needed to fully validate the addresses of interest for the diet node. However, this mechanism is not directly extensible to other types of DLT networks, such as DLT network based on smart contracts.

Other solutions propose mechanisms for a reduced capability ND to run the light client protocol to send transactions to the DLT network. However, these solutions assume that the intermediary ND connecting the reduced capability ND to the network is to be trusted and the transaction results obtained are consistent with a consistent global of the digital ledger.

Therefore, there is a need for a robust solution that enables reduced capability network devices to obtain a state of an account of interest in the DLT network regardless of the intermediary ND is a trusted device or not.

Mechanisms for Obtaining a State of an Account in the DLT Network

In one embodiment, a method performed by a network device for determining a state of an account of interest in a distributed ledger technology (DLT) network is described. The determination of the state of the account of interest is performed based on a DLT state indicator that is a representation of a state of the DLT network that is trusted by the network device. The network device determines whether the DLT state indicator is indicative of the state of the account of interest. Responsive to determining that the DLT state indicator is indicative of the state of the account of interest, the network device retrieves the state of the account of interest based on the DLT state indicator. Responsive to determining that the DLT state indicator is not indicative of the state of the account of interest, the network device performs the following operations: determining a first set of one or more transactions that include the account of interest, and executing the first set of transactions to obtain the state of the account of interest.

The embodiments of the present disclosure enable a network device running a light client protocol in a DLT network to limit the state space that the network device needs to follow consequently allowing the ND to gain the consistency and integrity security guarantees of the DLT network on the state space subset they are interested in. For example, in blockchain network, while previous solutions, allowed light clients to validate the internal consistency of individual block headers, the solution presented herein allow the light client to validate transactional consistency across blocks for a given set of accounts of interest.

Reducing the state space to a subset of the accounts recorded in the entire DLT network reduces the amount of computation, storage and network requirements by a similar ratio which is a measurable advantage of the present embodiments when compared with previous existing solutions.

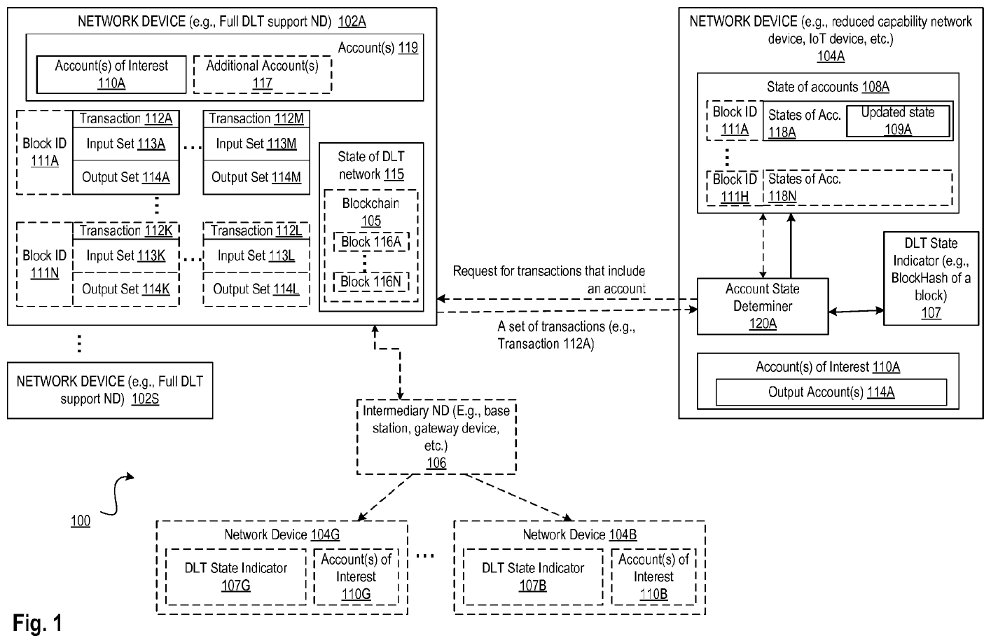

FIG. 1 illustrates a block diagram of an exemplary distributed ledger DLT network 100 for enabling a network device to determine a state of an account of interest based on a trusted state indicator of the DLT network, in accordance with some embodiments. In the following description the term node and network device will be alternatively used without departing from the scope of the present embodiments. In the following description some examples will be described for a particular type of DLT networks, namely the blockchain networks. However, the embodiments described herein generally to apply to other types of DLT networks, which will not necessarily be named herein.

The DLT network 100 includes a set of network devices 102A-S, a set of one or more network devices 104A-G, and one or more intermediary network devices 106. The various network devices communicate through a physical network (wired, wireless, or a combination of wired and wireless networking technology) that is not illustrated.

Each of the network devices 102A-S are electronic devices that are part of the DLT network and support full protocol of the DLT network. In other words, the network devices 102A-S can store and update a global digital ledger of the DLT network by performing conventional operations of digital ledger technology. The network devices 102A-S can execute transactions and validate them according to DLT protocols. For example, the network devices 102A-S can be full nodes of a smart contract-based blockchain. In another example, the network devices 102A-S can be full nodes of a blockchain network. The network device 102A is coupled with the network device 104A and with one or more optional network devices 104B-G. In some embodiments, the network device 102A is coupled with the NDs 104B-G through an intermediary ND 106.

The embodiments herein will be described with respect to an exemplary full node ND 102A. However, the network 100 can include several other network devices that operate as full nodes in the DLT network 100 and that will perform similar operations as the ones discuss with reference to ND 102A. The ND 102A stores a state 115 of the DLT network. The state 115 provides a global view of the transactions that occurred in the DLT network over time.

For example, when the DLT network is a blockchain network, the state 115 is the blockchain 105, which includes a set of blocks 116A-N that are linked to one another through secure cryptographic mechanisms. The blockchain network defines a set of rules that any valid transformation of a block Bₙ to block Bₙ₊₁ need to observe. These rules are enforced by full nodes such as ND 102A. When a full node encounters a block that does not observe these rules, it rejects the block and does not use it as part of the blockchain 105. Typically a full node such as ND 102A validates all the transactions of the blockchain to ensure that it has a view of the blockchain 105 that matches, with sufficiently high level of confidence, what the majority of the other nodes in the network 100 have.

The network device 102A further stores a set of one or more accounts 119 that include a set of accounts of interest 110A and potential additional accounts 117. The accounts 119 represent entities identified in the DLT network that can operate in the DLT network. For example, a user can use an account to generate transactions with other users. The accounts can be identified by an account identifier, which can be referred to as an address in the DLT network 100. The accounts 119 may include the accounts that are of interest to the network device 104A. The accounts of interest 110A are one or more accounts for which the network device 104A needs to obtain a current state. The accounts 119 may also include one or more additional accounts 117 that are different than the accounts of interest 110A.

The ND 102A is operative to execute transactions of the DLT network. For example, the ND 102A is operative to execute the transactions in all the blocks 116A-N, when the DLT network is a blockchain network. The ND 102A stores for each transaction executed an input set that includes identifiers of one or more accounts that are input to the transaction and an output set that includes identifiers of one or more accounts that are outputs of execution of the transaction. In the illustrated example of FIG. 1, ND 102A stores for each one of the transactions 112A-M a respective input set 113A-113M, and a respective output set 114A-M. In some embodiments, the transactions 112A-M are associated with a respective block ID 111A identifying the block in which the transactions 112A-N are stored in the blockchain 105. The ND 102A may include for multiple blocks 111A-N respective input sets and output sets for each transaction of the block.

The input set 113A includes a set of account identifiers identifying one or more accounts that are used as inputs in the transaction 112A. The output set 113A includes a set of account identifiers identifying one or more accounts that are modified by the transaction 112A. For example, in smart-contract based blockchains, a transaction that is a call to a smart contract includes in its input set at least the transaction initiator, whose account balance will be modified by the transaction processing costs, the smart contract itself, and any other accounts the smart contract execution accesses states from. While the ND 102A may be dishonest about a transaction's input set and/or output set, this does not affect the security of the solution presented herein. Any such malicious manipulation will be either detected during transaction evaluation by the ND 104A.

The ND 102A is operative to receive request for transactions that include an account and respond to the request. The transaction can include the accounts as an input, as an output, or as an input and an output. ND 102A transmits in response to the receipt of the request a set of one or more transactions that included the account of interest.

The intermediary ND 106 is an electronic device is part of the DLT network 100. The intermediary network device 106 is operative to connect the NDs 104B-G to other nodes of the DLT network. The intermediary network devices 106 acts as bottleneck to the ND 104B-G. ND 106 is operative to run a light client protocol to communicate with the NDs 104B-G. For example, the ND 106 can be a base station, a gateway device, a mobile device, or some other system providing a light ledger protocol service to the network devices 104B-G.

The network devices 104A-G are electronic devices that are operative to run a light client protocol with other network devices of the DLT network. The light client protocol allows the network devices 104A-G to query the state of the DLT network, send transactions, and check transaction results. However, these functionalities of the light client protocol do not provide the same security guarantees that are available to full DLT protocol operating in full nodes of the DLT network. Typically, a device running the light client protocol receives the DLT network's state from another device in the DLT network (e.g., ND 106 or ND 102A). This intermediary network device can be a malicious device and may not provide an accurate state of the DLT network to the reduced capability network device. For example, in a blockchain network, the intermediary network device can transmit to the reduced capability network device a state of the blockchain that may be internally consistent but is globally inconsistent.

The embodiments of the present disclosure allow ND 104A to obtain a state of one or more account of interest that are determined based on a trusted representation of the global state of DLT network 100 without requiring the ND 104A to execute and validate all the transactions of the digital ledger. ND 104A includes a state of accounts 108A, a DLT state indicator 107, an account state determiner 120A, and one or more accounts of interests 110A. The state of accounts 108A represent the state of accounts that were obtained by the ND 104A. The state of accounts 108A may include for each block 111A-H states of accounts associated with each one of the blocks. In these embodiments a single account may have a different state depending on the block for which its state is evaluated. ND 104A includes a set of accounts of interest 110A for which the ND 104A wishes to obtain the state. The account state determiner 120A is operative to request a set of transactions from the ND 102A, where the transactions include an account of interest. The transaction can include the account of interest as input, as an output, or both as an input and an output. In some embodiments, the ND 104A is interested to obtain a state of an account as it was modified, in this embodiment, the ND 104A transmits a request for transactions that have modified the account and therefore that include the account in the output set of the transaction. The ND 104A receives the set of transactions from the ND 102A and is operative to determine, based on the DLT state indicator 107, an updated state, e.g., updated states 109A for that account of interest. In some embodiments, the state of the account of interest is determined for a given bloc, e.g., for block 111A.

In some embodiments, the ND 104A has access to a DLT state indicator 107 prior to requesting any transactions from the ND 102A and updating states of accounts of interests. The DLT state indicator 107 is a representation of a state of the DLT network at a given time that is trusted by the ND 104A. In non-limiting exemplary embodiments, when the DLT network is a blockchain network, the state indicator can be a hash of a block from the blockchain. In another example a hash of block header can be used as a state indicator.

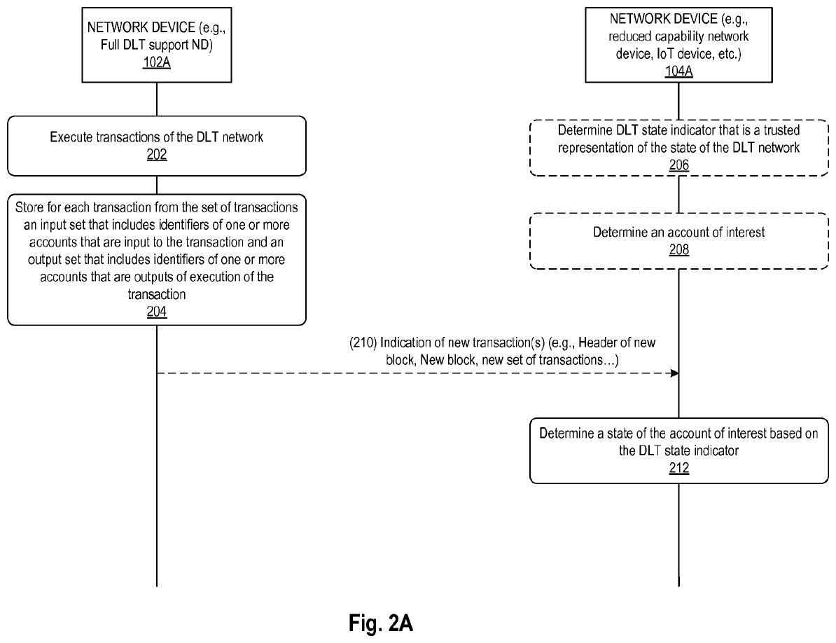

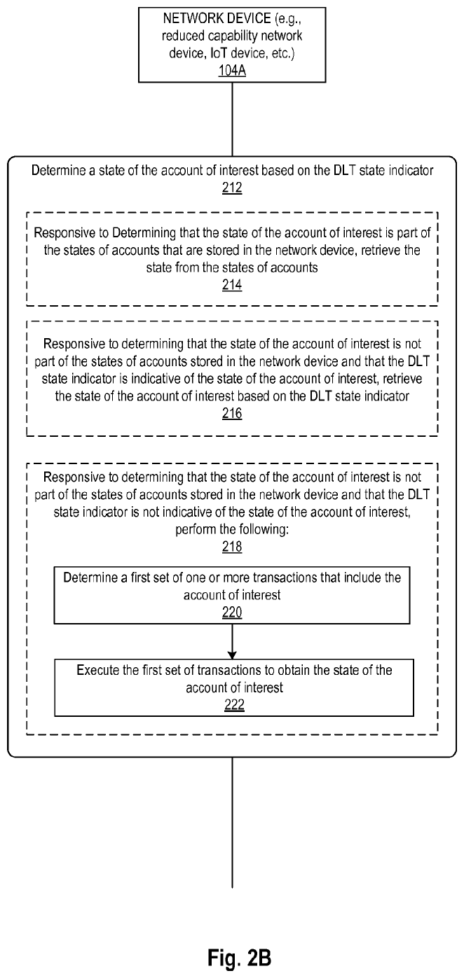

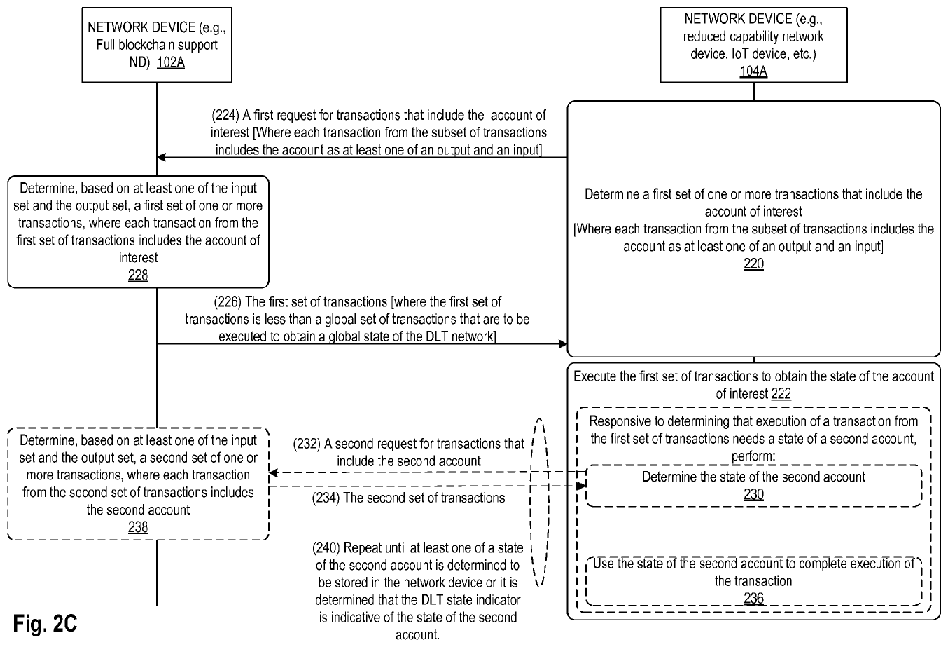

The operations of the various components of the system 100 will be described with reference to the operations performed in the transaction diagrams of FIGS. 2A-C.

FIG. 2A illustrates a block diagram of exemplary operations for obtaining a state indicator of the DLT network, in accordance with some embodiments. At operation 202, the ND 102A executes transactions of the DLT network. For example, the ND 102A executes the transactions in all the blocks 116A-N, when the DLT network is a blockchain network. At operation 206, the ND 102A stores for each transaction executed an input set that includes identifiers of one or more accounts that are input to the transaction and an output set that includes identifiers of one or more accounts that are outputs of execution of the transaction.

In the illustrated example of FIG. 1, ND 102A stores for each one of the transactions 112A-M a respective input set 113A-113M, and a respective output set 114A-M. In some embodiments, the transactions 112A-M are associated with a respective block ID 111A identifying the block in which the transactions 112A-N are stored in the blockchain 105. The ND 102A may include for multiple blocks 111A-N respective input sets and output sets for each transaction of the block.

The input set 113A includes a set of account identifiers identifying one or more accounts that are used as inputs in the transaction 112A. The output set 113A includes a set of account identifiers identifying one or more accounts that are modified by the transaction 112A.

The ND 104A has access to a DLT state indicator 107 prior to requesting any transactions from the ND 102A and updating states of accounts of interests. In some embodiments, ND 104A is operative to determine, at operation 206, the DLT state indicator 107. Several methods can be used to determine the DLT state indicator 107 without departing from the scope of the present disclosure. The DLT state indicator 107 is considered a ground truth that enables the ND 104A to obtain one or more states of accounts of interest.

The ND 104A has a set of one or more accounts of interest for which it wants to obtain a state update. In some embodiments, ND 104A determines, operation 208, the one or more accounts of interest. For example, the ND 104A may be configured during an initial configuration operation with the accounts of interests.

In some embodiments, the ND 104A may receive an indication of new transaction(s) that occurred in the DLT network 100 and which include one or more of the accounts of interest of the ND 104A. For example, the ND 104A may receive a header of new block, a new block, or more generally a set of new transactions that occurred in the DLT network 100. In these embodiments, this indication can trigger the operation 212 in ND 104A. At operation 212, ND 104A determines a state of the account of interest based on the DLT state indicator 107. This determination is performed in collaboration with ND 102A as it is discussed in further details with respect to FIGS. 2B-C. While in some embodiments, operation 212 is performed as a result of the receipt of the indication of new transactions in the DLT network 100, in other embodiments, operation 212 is performed without receiving any triggering element. For example, the ND 104A may periodically attempt to determine an update of its account of interest. In other embodiments, the ND 104A may determine the update as a result of internal operations of the ND itself.

FIG. 2B illustrates a block diagram of exemplary operations for determining a state of an account of interest in the DLT network based on the state indicator, in accordance with some embodiments. In some embodiments, the determination of the state of account of interest includes one or a combination of the operations 214, 216, and 218.

At operation 214 responsive to determining that the state of the account of interest is part of the states of accounts that are stored in the network device, the ND 104A retrieves the state from the states of accounts. In some embodiments, the network device ND 104A may already have stored a state of an account of interest and may obtain the state of the account of interest from the set of states stored. In other embodiments, the state of the account of interest is not yet known to the ND 104A and the flow of operations moves to operation 216.

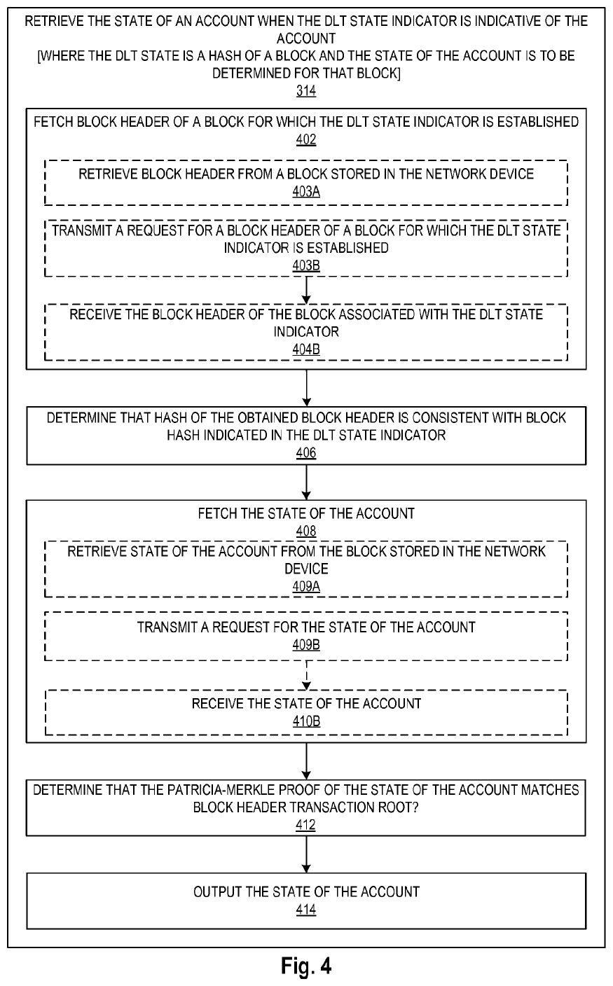

At operation 216, responsive to determining that the state of the account of interest is not part of the states of accounts stored in the network device and that the DLT state indicator 107 is indicative of the state of the account of interest, the ND 104A retrieves the state of the account of interest based on the DLT state indicator. In some embodiments, retrieving the state of the account of interest based on the DLT state indicator 107 is performed as described in further details in FIG. 4.

At operation 218, responsive to determining that the state of the account of interest is not part of the states of accounts stored in the network device and that the DLT state indicator is not indicative of the state of the account of interest, the ND 104A performs operation 220-222. At operation 220, the ND 104A determines a first set of one or more transactions that include the account of interest. Upon determination of the first set of transactions that include the account of interest, the flow moves to operation 222, at which the ND 104A executes the first set of transactions to obtain the state of the account of interest.

FIG. 2C illustrates a block diagram of exemplary operations for determining a state of an account of interest in the DLT network based on the state indicator, in accordance with some embodiments. Upon determining that the state of the account of interest is not part of the states of accounts stored in the network device and that the DLT state indicator is not indicative of the state of the account of interest, the ND 104A performs operations 220 and 222. In some embodiments, determining a first set of one or more transactions that include the account of interest includes transmitting a request, 224, for transactions that include the account of interest. The ND 104A requests to obtain the transactions that may modify the state of the account, i.e., transactions in which the account of interest is an output, the transactions where the account of interest may be an input, or transactions that may include the account of interest as an input and as an output. In some embodiments, when the DLT network is a blockchain network, the request can be for transactions that include the account of interest for a given block. For example, the request for the transactions may include an account identifier and a block identifier.

The request 224 is received by the ND 102A, which determines, at operation 228, based on at least one of the input set and the output set that are stored on the ND, a first set of transactions. The first set of transactions includes the account of interest. The first set of transactions is determined by looking up in the input set and the output set stored in the ND 102A the transactions that include the account of interest. For example, the ND 102A is operative to determine the transactions that modify the account of interest, i.e., include the account of interest as an output, include the account of interest as an input, or include the account of interest as both an input and an output. In some embodiments, when the DLT network is a blockchain network, the determination of the transactions that include the account of interest is performed for a given block. For example, the request for the transactions may include an account identifier and a block identifier and the determination is performed for the block identifier and account identifier. In some embodiments, the first set of transactions is less than a global set of transactions that are to be executed to obtain a global state of the DLT network. For example, when the DLT network includes several accounts and each account is associated with one or more transactions, the first set of transactions that is determined and transmitted to the ND 104A is a subset of all transactions of the transactions that occurred in the DLT network for all of the accounts. In these embodiments, the first of transactions is only a subset of all the transactions that occurred and recorded in the DLT network.

The flow of operations moves to operation 222, at which the ND 104A executes the first set of transactions to obtain the state of the account of interest. In some embodiments, the execution of the first set of transactions results in the update of the state of the account of interest. In other embodiments, the execution of the first set of transactions may result in the need to obtain the state of one or more additional accounts in order to complete execution of the transactions of the first set. In these embodiments, the ND 104A is operative to perform operations 230 and 236 to obtain the state of the additional accounts. For example, the execution of the transactions that include the account of interest may result in the determination of a second account of which state is needed to complete the execution of the transactions.

At operation 230, the ND 104A determines a state of a second account. To determine a state of the second account, the ND 104A needs to determine a second set of transactions that include the second account. In some embodiments, the state of the second account that is to be determined is a state of an account that is different from the account of interest. In other embodiments, the state of the second account is a state of the account of interest in a block that is different from the block identifier in the first request 224. For example, the execution of a given transaction for an account in a first block may need to obtain the state of that same account as it was determined in a second block that precedes the first block in the blockchain. Thus, while the ND 104A is described as needing to determine a state of a second account, the second account can be the same account as the account of interest but for a different block.

Determining the second set of transactions includes transmitting a second request, 232, for transactions that include the second account. The ND 104A requests to obtain the transactions that may modify the state of the second account, i.e., transactions in which the second account is an output; the transactions where the second account is an input, or transactions that may include the second account as an input and as an output. In some embodiments, when the DLT network is a blockchain network, the request can be for transactions that include the second account for a given block. For example, the request for the transactions may include an account identifier and a block identifier. In some embodiments, the block identified for the second account is the same as the block identified for obtaining the transactions for the account of interest. In other embodiments, the block identified for the second account is a block that precedes the blocks identified for obtaining the transactions for the account of interest.

The second request 232 is received by the ND 102A, which determines, at operation 238, based on at least one of the input set and the output set that are stored on the ND, a second set of transactions. The second set of transactions includes the second account. The second set of transactions is determined by looking up in the input set and the output set stored in the ND 102A the transactions that include the second account. For example, the ND 102A is operative to determine the transactions that modify the second account, i.e., include the second account as an output, include the second account as an input, or include the second account as both an input and an output. In some embodiments, when the DLT network is a blockchain network, the determination of the transactions that include the second account is performed for a given block. For example, the second request for the transactions may include an account identifier and a block identifier and the determination is performed for the block identifier and account identifier. In some embodiments, the second set of transactions is less than a global set of transactions that are to be executed to obtain a global state of the DLT network.

Following the receipt of the second set of transaction, the ND 104A executes the second set of transactions to obtain the state of the second account. In some embodiments, the execution of the second set of transactions results in the update of the state of the second account. Once the state of the second account is obtained, the ND 104A uses the state of the second account to complete execution of the transactions for the account of interest, at operation 236.

In other embodiments, the execution of the second set of transactions may result in the need to obtain the state of one or more additional accounts in order to complete execution of the transactions of the second set and the transactions of the first set. In these embodiments, the ND 104A repeats the operations of determining the state of an account, for each one of these additional accounts, as described with reference to FIG. 2B (which may include requesting for transactions and executing the transactions) until at least one of the state of the account is determined to be stored in the network device or it is determined that the DLT state indicator is indicative of the state of the account.

The operations in the flow diagrams will be described with reference to the exemplary embodiments of FIGS. 1 and 2A-C. However, it should be understood that the operations of the flow diagrams can be performed by embodiments of the disclosure other than those discussed with reference to FIGS. 1 and 2A-C, and the embodiments of the disclosure discussed with reference to these other figures can perform operations different than those discussed with reference to the flow diagrams.

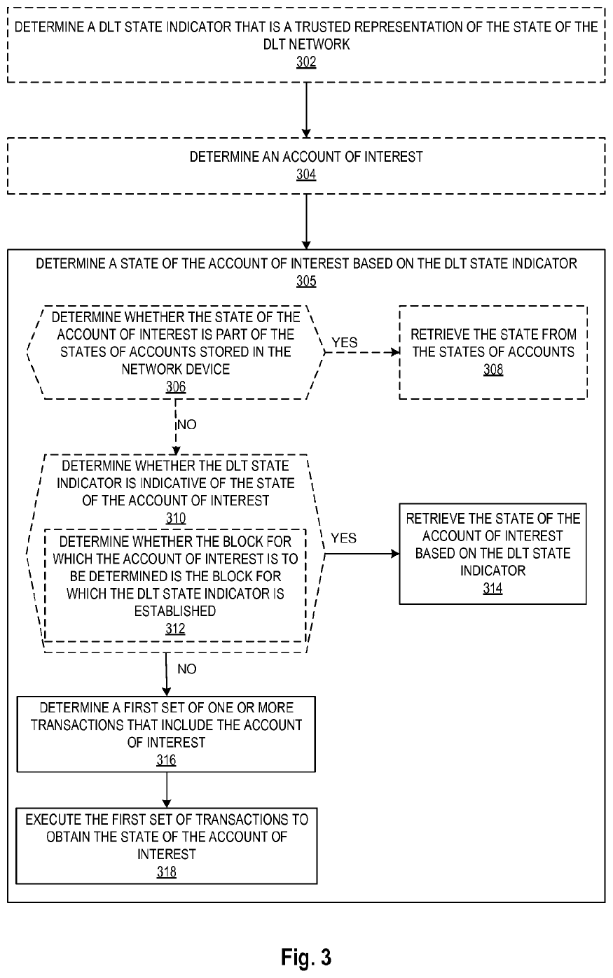

FIG. 3 illustrates a flow diagram of exemplary operations for determining a state of an account of interest based on a state indicator of the DLT network, in accordance with some embodiments. The operations of the flow diagram in FIG. 3 can be performed by a network device such as ND 104A. At operation 302, the ND 104A determine a DLT state indicator that is a trusted representation of the state of the DLT network. This operation is optional and can be skipped in some embodiments. For example, a state indicator can already be known to the ND 104A and there is no need for a determination of the DLT state indicator. The ND 104A has access to a DLT state indicator 107 prior to requesting any transactions from the ND 102A and updating states of accounts of interests. Several methods can be used to determine the DLT state indicator 107 without departing from the scope of the present embodiments. The DLT state indicator 107 is considered a ground truth that enables the ND 104A to obtain one or more states of accounts of interest. The ND 104A has a set of one or more accounts of interest for which it wants to obtain a state update. In some embodiments, ND 104A determines, operation 304, the accounts of interest. For example, the ND 104A may be configured during an initial configuration operation with the accounts of interests.

At operation 305, the ND 104A determines a state of the account of interest based on the DLT state indicator. The determination of the state of the account of interest includes operations 306-318. At operation 306, the ND 104A determines whether the state of the account of interest is part of the states of accounts stored in the network device. Upon determining that the state of the account is stored in the ND 104A, the ND 104A retrieves the state from the states of accounts. Alternatively, upon determining that the state of the account is not stored in the ND 104A, the flow of operations moves to operation 310.

At operation 310, the ND 104A determines whether the DLT state indicator is indicative of the state of the account of interest. In some embodiments, when the DLT network is blockchain network, determining whether the DLT state indicator is indicative of the state of the account of interest includes determining whether the block for which the account of interest is to be determined is the block for which the DLT state indicator is established. For example, the DLT state indicator can be a hash of a block header of a given block and the account of interest is to be determined for that block. In this example, the DLT state indicator is determined to be indicative of the state of the account of interest.

Upon determining that the state of the account of interest is indicative of the state of the account of interest, the flow of operations moves to operation 314. Alternatively, upon determining that the state of the account of interest is not indicative of the state of the account of interest, the flow of operations moves to operation 316. At operation 316, the ND 104A determines a first set of one or more transactions that include the account of interest and executes the first set of transactions, at operation 318, to obtain the state of the account of interest.

FIG. 4 illustrates a flow diagram of exemplary operations for retrieving the state of an account when the DLT state indicator is indicative of the account, in accordance with some embodiments. The operations of FIG. 4 are exemplary operations that can be performed when the DLT network 100 is a blockchain network for retrieving the state of the account when the DLT state indicator is a hash of a block header and the state of the account is to be determined for that block. At operation 402, ND 104A fetches a block header of the block for which the DLT state indicator is established. In some embodiments, fetching the block header may include operation 403A, at which the ND 104A retrieves a block header from a block stored in the network device. Alternatively, if the block header is not stored in the network device, the ND 104A transmits a request for a block header of the block for which the DLT state indicator is established, at operation 403B. The flow of operations moves then to operation 404B, at which the ND 104A receives the block header of the block associated with the DLT state indicator.

At operation 406, a verification operation is performed by determining that a hash of the received block header is consistent with a block hash indicated in the DLT state indicator. For example, when the DLT state indicator is a hash of a block header, the determination is performed by hashing the received block header and comparing the result with the stored hash of the block header.

Upon verification of the hash of the block header, the ND 104A fetches, at operation 408, the state of the account. In some embodiments, fetching the state of the account may include operation 409A, at which the ND 104A retrieves the state of the account from the block stored in the network device. Alternatively, the ND 104A may transmit a request for the state of the account at operation 409B and receive the state of the account, at operation 410B.

Upon receipt of the state of the account, the ND 104A may determine, at operation 412, that the Patricia-Merkle proof of the state of the account matches the root of the block header. While the embodiments herein describe the use of a Patricia-Merkle proof, in other embodiments, other mechanisms of partial validation can be used without departing from the scope of the present inventive concept.

Once the verification is complete, the ND 104A outputs the state of the account at operation 414.

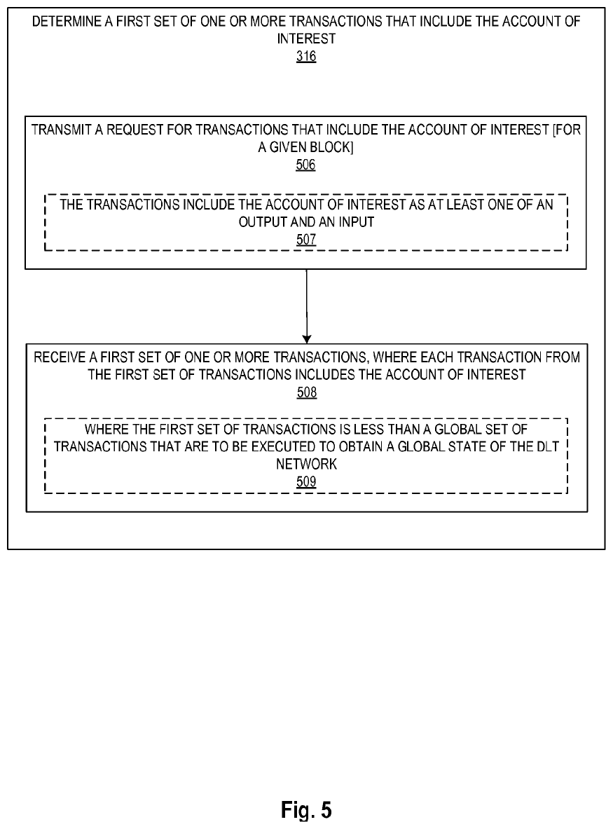

FIG. 5 illustrates a flow diagram of exemplary operations for determining a set of transactions that include the account of interest, in accordance with some embodiments. At operation 506, the ND 104A transmits a request for transactions that include the account of interest. In some embodiments, the transactions include the account of interest as at least one of an output and an input. The transactions can include the account of interest as input, as an output, or both as an input and an output. In some embodiments, the ND 104A is interested to obtain a state of an account as it was modified, in this embodiment, the ND 104A transmits a request for transactions that have modified the account and therefore that include the account in the output set of the transaction. In some embodiments, the request can include the identifier of the account and an identifier of the block for which the state of the account is to be determined. In other embodiments, the request includes the account identifier.

At operation 508, the ND 104A receives a first set of one or more transactions, where each transaction from the first set of transactions includes the account of interest. In some embodiments, the first set of transactions is less than a global set of transactions that are to be executed to obtain a global state of the DLT network. For example, when the DLT network includes several accounts and each account is associated with one or more transactions, the first set of transactions that is determined and transmitted to the ND 104A is a subset of all transactions of the transactions that occurred in the DLT network for all of the accounts. In these embodiments, the first of transactions is only a subset of all the transactions that occurred and recorded in the DLT network.

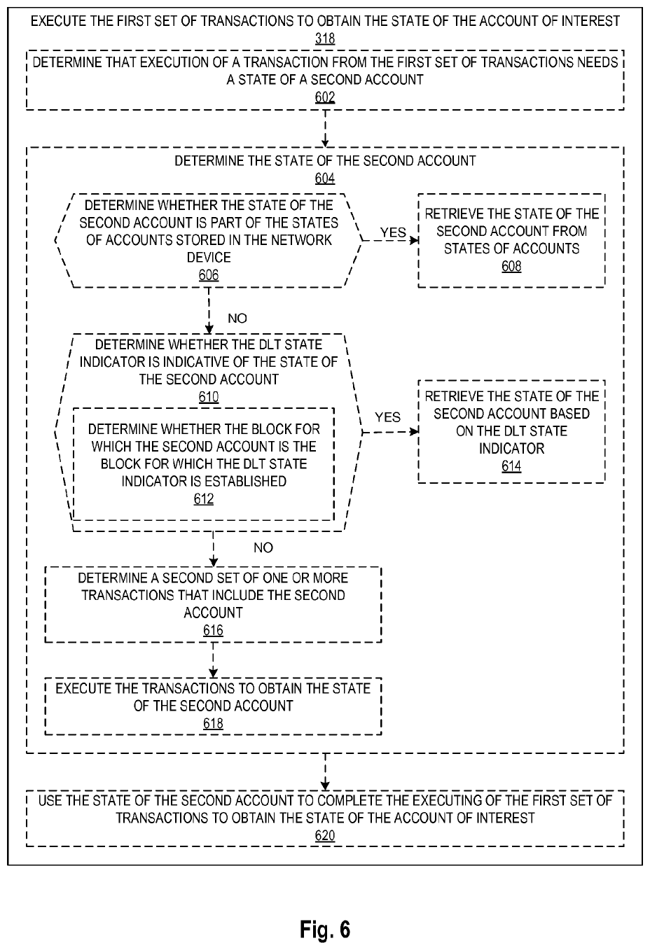

FIG. 6 illustrates a flow diagram of exemplary operations for executing the first set of transactions to obtain the state of the account of interest, in accordance with some embodiments. At operation 602, the ND 104A determines that execution of a transaction from the first set of transactions needs a state of a second account. Upon determination that the execution of a state of a second account is needed, the ND 104A determines the state of the accounts by performing operations 606-618. Upon determination of the state of the second account, the ND 104A uses, at operation 620, the state of the second account to complete execution of the first set of transactions and obtain the state of the account of interest.

At operation 606, the ND 104A determines whether the state of the second account is part of the states of accounts stored in the network device. Upon determining that the state of the second account is stored in the ND 104A, the ND 104A retrieves, operation 608, the state from the states of accounts. Alternatively, upon determining that the state of the account is not stored in the ND 104A, the flow of operations moves to operation 610.

At operation 610, the ND 104A determines whether the DLT state indicator is indicative of the state of the second account. In some embodiments, when the DLT network is a blockchain network, determining whether the DLT state indicator is indicative of the state of the second account includes determining whether the block for which the second account is to be determined is the block for which the DLT state indicator is established. For example, the DLT state indicator can be a hash of a block header of a given block and the second account is to be determined for that block. In this example, the DLT state indicator is determined to be indicative of the state of the second account.

Upon determining that the state of the second account is indicative of the state of the account of interest, the flow of operations moves to operation 614. Alternatively, upon determining that the state of the account of interest is not indicative of the state of the second account, the flow of operations moves to operation 616. At operation 616, the ND 104A determines a second set of one or more transactions that include the second account and executes the second set of transactions, at operation 618, to obtain the state of the second account.

In some embodiments, the execution of the second set of transactions may result in the need to obtain the state of one or more additional accounts in order to complete execution of the transactions of the second set and the transactions of the first set. In these embodiments, the ND 104A repeats the operations of determining the state of accounts as described (which may include requesting for transactions and executing the transactions) until at least one of the state of the account is determined to be stored in the network device or it is determined that the DLT state indicator is indicative of the state of the account.

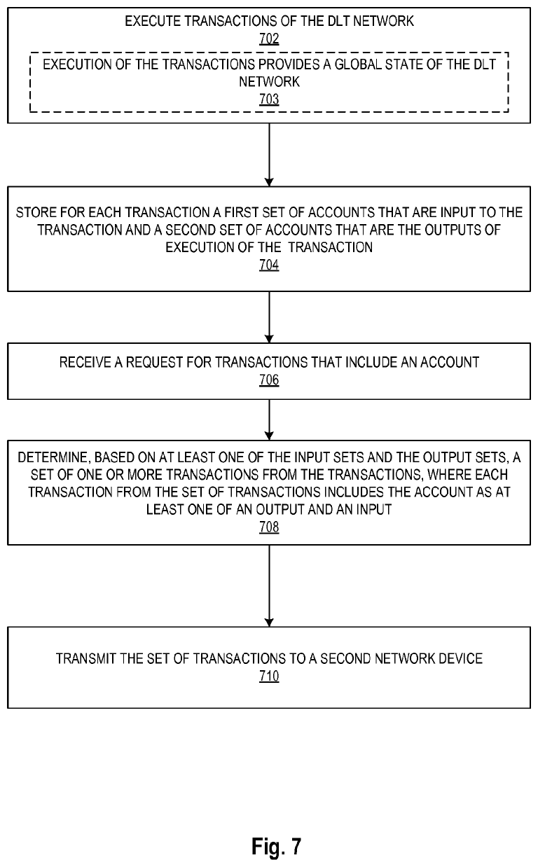

FIG. 7 illustrates a flow diagram of exemplary operations performed in a network device operating as a full DLT node, in accordance with some embodiments. At operation 702, the ND 102A executes transactions of the DLT network 100. In some embodiments, the execution of the transactions provides, operation 703, a global state of the DLT network. The flow of operation moves to operation 703, at which the ND 102A stores for each transaction a first set of accounts that are input to the transaction and a second set of accounts that are the outputs of execution of the transaction. At operation 706, the ND 102A receives a request for transactions that include an account. The transaction can include the account as an input account, such that a state of the account is needed to execute the transaction. The transaction can alternatively or additionally include the account as an output such that the state of the account is modified by the execution of the transaction.

The flow of operation moves to operation 708, at which the ND 104A determines, based on at least one of the input sets and the output sets, a set of one or more transaction that include the account. Upon determination of the transactions, the ND 104A transmits, at operation 710, the set of transactions to a second network device, e.g., ND 104A.

The embodiments of the present disclosure enable a network device running a light client protocol in a DLT network to limit the state space that the network device needs to follow consequently allowing the ND to gain the consistency and integrity security guarantees of the DLT network on the state space subset they are interested in. For example, in blockchain network, while previous solutions, allowed light clients to validate the internal consistency of individual block headers, the solution presented herein allow the light client to validate transactional consistency across blocks for a given set of accounts of interest.

Reducing the state space to a subset of the accounts recorded in the entire DLT network reduces the amount of computation, storage and network requirements by a similar ratio which is a measurable advantage of the present embodiments when compared with previous existing solutions.

Architecture:

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the disclosure may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video, etc.). In the embodiments described above the components of the DLT network 100 can be implemented on one or more network devices coupled through a physical network. For example, each of the ND 102A and the intermediary network devices 106 can be implemented on one ND or distributed over multiple NDs. In some embodiments, the ND 104 is a network device of reduced capability with limited processing, storage, and networking resources.

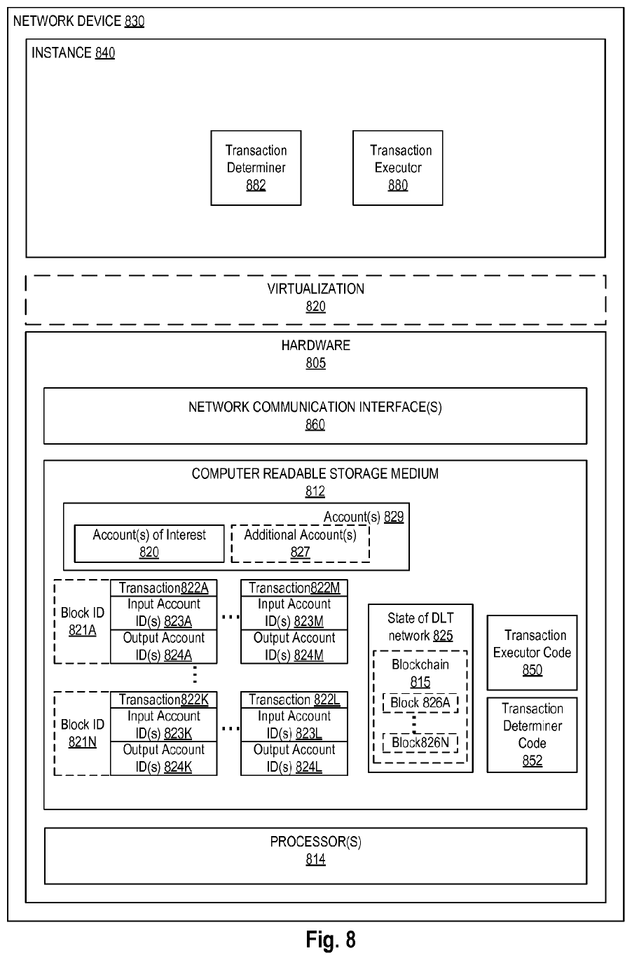

FIG. 8 illustrates a block diagram for a network device that can be used for implementing one or more of the network devices described herein, in accordance with some embodiments. The network device 830 may be a web or cloud server, or a cluster of servers, running on server hardware. According to one embodiment, the network device is a server device which includes hardware 805. Hardware 805 includes one or more processors 814, network communication interfaces 860 coupled with a computer readable storage medium 812. The computer readable storage medium 812 may include transaction executor code 850 and transaction determiner code 852. In some embodiments, the various codes stored in the computer readable storage medium 812 can be stored in separate readable storage media elements such that the different component are physically separate from one another.

While one embodiment does not implement virtualization, alternative embodiments may use different forms of virtualization represented by a virtualization layer 820. In these embodiments, the instance 840 and the hardware that executes it form a virtual server which is a software instance of the modules stored on the computer readable storage medium 812.

Each of the network transaction executor code 850 and transaction determiner code 852 includes instructions which when executed by the hardware 805 causes the instance 840 to respectively implement transaction executor 880 and transaction determiner 882 that are operative to perform the operations performed by ND 102 described with reference to FIGS. 1-7.

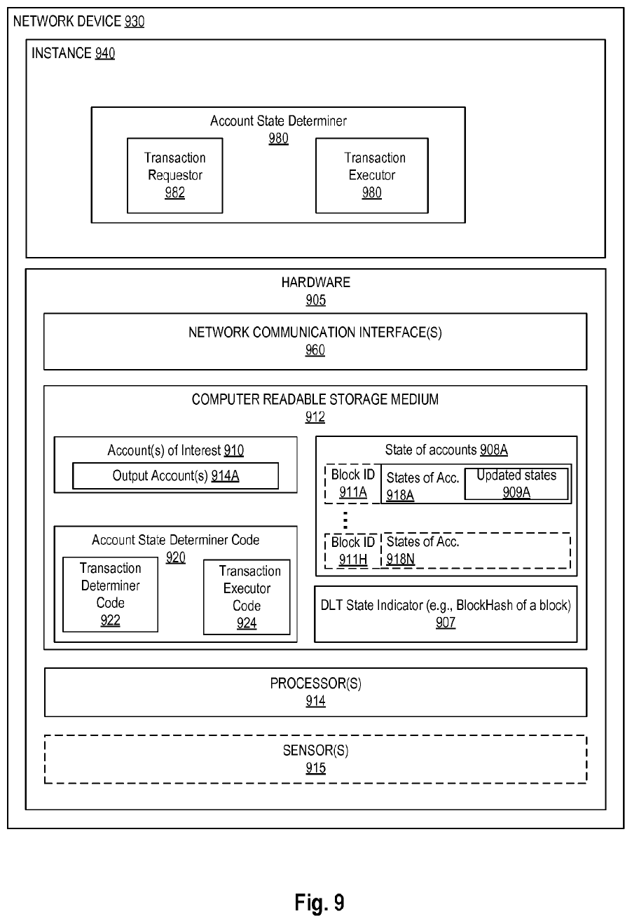

FIG. 9 illustrates a block diagram for a network device that can be used for implementing a reduced network device, in accordance with some embodiments. The ND 104 is a network device as illustrated in FIG. 9. The network device 930 may be a network device of reduced capability that has limited processing, storage, and/or networking capabilities. For example, ND 930 can be IoT device. The ND 930 may include hardware 905. Hardware 905 includes one or more processors 914, network communication interfaces 960 coupled with a computer readable storage medium 912, and optional one or more sensor(s) 915. The computer readable storage medium 912 may include account state determiner code 920, which includes transaction determiner code 922 and transaction executor code 924.

The account state determiner code 920, which includes transaction determiner code 922 and transaction executor code 924, includes instructions which when executed by the hardware 805 causes the instance 840 to respectively implement account state determiner 980, which includes transaction determiner 982 and transaction executor 984 that are operative to perform the operations performed by the ND 104 described with reference to FIGS. 1-7.

While the flow diagrams in the figures show a particular order of operations performed by certain embodiments of the disclosure, it should be understood that such order is exemplary (e.g., alternative embodiments may perform the operations in a different order, combine certain operations, overlap certain operations, etc.).

While the disclosure has been described in terms of several embodiments, those skilled in the art will recognize that the disclosure is not limited to the embodiments described, can be practiced with modification and alteration within the spirit and scope of the appended claims. The description is thus to be regarded as illustrative instead of limiting.

1. A method performed by a network device of determining a state of an account of interest in a distributed ledger technology (DLT) network, the method comprising:
determining whether a DLT state indicator is indicative of the state of the account of interest, wherein the DLT state indicator is a representation of a state of the DLT network that is trusted by the network device;
responsive to determining that the DLT state indicator is indicative of the state of the account of interest, retrieving the state of the account of interest based on the DLT state indicator; and
responsive to determining that the DLT state indicator is not indicative of the state of the account of interest, performing the following:
determining a first set of one or more transactions that include the account of interest, and
executing the first set of transactions to obtain the state of the account of interest.

2. The method of claim 1, wherein determining the first set of one or more transactions that include the account of interest includes:
transmitting a request for transactions that include the account of interest; and
receiving the first set of one or more transactions, where each transaction from the first set of transactions includes the account of interest.

3. The method of claim 1, wherein each transaction from the first set of transactions includes the account of interest as at least one of an output and an input.

4. The method of claim 1, wherein executing the first set of transactions to obtain state of the account of interest includes:
determining that execution of a transaction from the first set of transactions needs a state of a second account;
determining the state of the second account; and
using the state of the second account to complete the executing of the first set of transactions to obtain the state of the account of interest.

5.-12. (canceled)

13. A network device for determining a state of an account of interest in a distributed ledger technology (DLT) network, the network device comprising:
one or more processors; and
a computer readable storage medium storing a set of computer readable instructions that when executed by the one or more processors cause the network device to:
determine whether the DLT state indicator is indicative of the state of the account of interest, wherein the DLT state indicator is a representation of a state of the DLT network that is trusted by the network device,
responsive to determining that the DLT state indicator is indicative of the state of the account of interest, retrieve the state of the account of interest based on the DLT state indicator, and
responsive to determining that the DLT state indicator is not indicative of the state of the account of interest, perform the following:
determine a first set of one or more transactions that include the account of interest, and
execute the first set of transactions to obtain the state of the account of interest.

14. The network device of claim 13, wherein to determine the first set of one or more transactions that include the account of interest includes to:
transmit a request for transactions that include the account of interest; and
receive the first set of one or more transactions, where each transaction from the first set of transactions includes the account of interest.

15. The network device of claim 13, wherein each transaction from the first set of transactions includes the account of interest as at least one of an output and an input.

16. The network device of claim 13, wherein to execute the first set of transactions to obtain the state of the account of interest includes to:
determine that execution of a transaction from the first set of transactions needs a state of a second account;
determine the state of the second account; and
use the state of the second account to complete the executing of the first set of transactions to obtain the state of the account of interest.

17. The network device of claim 16, wherein to determine the state of the second account includes to:
determine whether the state of the second account is part of states of accounts stored in the network device; and
responsive to determining that the state of the second account is part of the states of accounts stored in the network device, retrieve the state of the second account from the states of accounts.

18. The network device of claim 17, wherein to determine the state of the second account includes to:
responsive to determining that the state of the second account is not part of the states of accounts stored in the network device, determine whether the DLT state indicator is indicative of the state of the second account,
responsive to determining that the DLT state indicator is indicative of the state of the account of interest, retrieve the state of the account of interest based on the DLT state indicator, and
responsive to determining that the DLT state indicator is not indicative of the state of the account of interest, perform the following:
determine a second set of one or more transactions that include the second account, and
execute the transactions to obtain the state of the second account.

19. The network device of claim 13, wherein the DLT network is a blockchain network and the DLT state indicator is an identifier of a block that is trusted by the network device.

20. The network device of claim 19, wherein the network device has at least one of limited computing, networking, and storage resources.

21. The network device of claim 19, wherein the network device is operative to run a light blockchain protocol.

22. The network device of claim 19, wherein the first set of transactions is received from another network device operative to run a full blockchain protocol.

23. A method performed by a first network device in a distributed ledger technology (DLT) network, the method comprising:
executing transactions of the DLT network;
storing for each transaction from the transactions an input set that includes identifiers of one or more accounts that are input to the transaction and an output set that includes identifiers of one or more accounts that are outputs of execution of the transaction;
receiving from a second network device, a request for transactions that include an account;
determining based on at least one of the input sets and the output sets, a set of one or more transactions from the transactions, wherein each transaction from the set of transactions includes the account as at least one of an output and an input; and
transmitting the set of transactions to the second network device.

24.-29. (canceled)

30. A first network device in a distributed ledger technology (DLT) network, the first network device comprising:
one or more processors; and
a computer readable storage medium storing a set of computer readable instructions that when executed by the one or more processors cause the first network device to:
execute transactions of the DLT network;
store for each transaction from the transactions an input set that includes identifiers of one or more accounts that are input to the transaction and an output set that includes identifiers of one or more accounts that are outputs of execution of the transaction;
receive, from a second network device, a request for transactions that include an account;
determine, based on at least one of the input sets and the output sets, a set of one or more transactions from the transactions, wherein each transaction from the set of transactions includes the account as at least one of an output and an input; and
transmit the set of transactions to the second network device.

31. The first network device of claim 30, wherein to execute of the set of transactions provides a global state of the DLT network.

32. The first network device of claim 30, wherein the DLT network is a blockchain network and the request for transactions is a request for transactions of a first block of a blockchain recorded in the blockchain network and the set of transactions is stored in the first block.

33. The first network device of claim 32, wherein the second network device is operative to run a light blockchain protocol.

34. The first network device of claim 30, wherein the second network device has at least one of limited computing, networking, and storage resources.
